(19) United States
(12) Patent Application Publication
(10) Pub. No.: US 2008/0064843 A1
(43) Pub. Date: Mar. 13, 2008

(54) Polymers with pendant alkyl chains

(76) Inventor: Thomas Daly, Arlington Heights, IL (US)

Correspondence Address: Clifford Kraft, 320 Robin Hill Dr., Neperville, IL, 60540, US

(21) Appl. No.: 11/983,377

(22) Filed: Nov. 8, 2007

Related U.S. Application Data
(63) Continuation-in-part of application No. 10/666,584, filed on Sep. 18, 2003.
(60) Provisional application No. 60/411,907, filed on Sep. 19, 2002.

(51) Int. Cl. C08G 69/26; C08G 77/26

(52) U.S. Cl. 528/31; 528/332

(57) ABSTRACT

A hydrophobic polymer made by incorporating alkyl chains pendant to the main backbone of the polymer. The present invention allows creating polymers with alkyl chains pendant to the polymer chain. Synthetic and naturally derived starting materials such as tallow diamine or ethoxylated tallow amine typically contain a mixture of chain lengths with varying degrees of branching and unsaturation. The unsaturated positions in the final polymer can be made to cross-link in the presence of a catalyst to increase the hardness and reduce the effect of heat and solvent borne exposures. The present invention can be a replacement to current monomers or additive to common polymers to replace or modify the current polymers to alter the properties of a polymer adding the known benefits of fatty compounds to common polymers such as hydrophobicity, or in altering the HLB (hydrophilic lipophilic balance) of polymeric surfactants. While the preferred embodiment of the present invention is directed primarily to urea and urethane polymers, the invention is also useful in the incorporation of pendant alkyl structures in other types of polymers that use an amine or alcohol groups to form the linkage. Other polymer types which can utilize this invention include, but are not limited to the following: polyamide, polyester, polycarbonate, polyether, polysiloxane, and epoxy.

This application is a continuation-in-part of co-pending application Ser. No. 10/666,584 filed Sep. 18, 2003 which claimed priority from U.S. Provisional application No. 60/411,907 filed Sep. 19, 2002. Application Ser. Nos. 10/666,584 and 60/411,907 are hereby incorporated by reference.

### BACKGROUND

1. Field of the Invention

The present invention relates generally to the field of polymers and more particularly to a class of polymers with pendant alkyl chains.

2. Description of the Problem Solved by the Invention

Polymers are very useful compounds that have a wide range of applications. It is known that different monomers allow the customization of properties of the polymer to suit the intended end use. A particular property that is very useful is that of hydrophobicity. A polymer with hydrophobic properties repels water and thus finds great use whenever this property is desired. This type of polymer is particularly useful as a coating, especially if it can be sprayed on.

The most common method of adding hydrophobicity to a surface is the use of waxes. Stains and other coatings often incorporate a wax to increase the surface tension of water. The disadvantages are the possible adverse effect on the adhesion, short service life due to oxidation and the relative ease of removal, either by mechanical means or through washing and leaching if incorporated into a coating. This method would not be suitable for a low-drag marine coating. Another method is the use of PTFE polymer or incorporation of PTFE polymers into the coating. The use of PTFE is prohibitive in most coatings applications.

U.S. Pat. No. 3,936,409 describes the synthesis of urea urethanes that can be used to protect various substrates from water, but these polymers do not have substantial hydrophobicity for many applications. U.S. Pat. No. 3,936,409 is hereby incorporated by reference.

What is badly needed is a polymer that can be made cheaply and can possibly be sprayed on to form a water repellant coating.

### SUMMARY OF THE INVENTION

The present invention relates to a hydrophobic polymer made by incorporating alkyl chains pendant to the main backbone of the polymer. Alkyl chains of from about 6 to over 22 carbons are present in fatty compounds well known in the art. The present invention allows creating polymers with these alkyl chains pendant to the polymer chain. It is well known that synthetic and naturally derived starting materials such as tallow diamine or ethoxylated tallow amine typically contain a mixture of chain lengths with varying degrees of branching and unsaturation. The unsaturated positions in the final polymer can be made to cross-link in the presence of a catalyst to increase the hardness and reduce the effect of heat and solvent borne exposures.

The present invention can be a replacement to current monomers or additive to common polymers to replace or modify the current polymers to alter the properties of a polymer. The present invention adds the known benefits of fatty compounds to common polymers such as hydrophobicity, or in altering the HLB (hydrophilic lipophilic balance) of polymeric surfactants.

The present invention is directed primarily to urea and urethane polymers, but can be useful in the incorporation of pendant alkyl structures in other types of polymers that use an amine or alcohol groups to form the linkage. Other polymer types which can utilize this invention include, but are not limited to the following: polyamide, polyester, polycarbonate, polyether, polysiloxane, and epoxy.

### DETAILED DESCRIPTION OF THE INVENTION

It is well known in the art to combine polyols or polyol pre-polymers with organic isocyanates and other materials to form polymers and polymeric resins. In particular, paints and coatings often contain polyurethane or other polymeric coating materials derived from an amine or alcohol functional monomer. A generic urethane has the following structure: 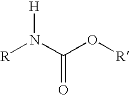
It is well known in the art that R and R′ can be the same or different. A typical polyurethane polymer is made up of chains of the form: 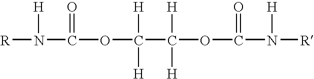
or of the form:

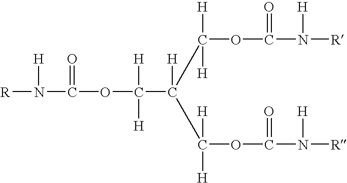

Multifunctional fatty compounds, such as polyamines or ethoxylated amines, can be reacted with isocyantes to form polymers or pre-polymers that have uses in coatings, films, fibers, or structural components. In particular, ethoxylated fatty acids can be combined with organic isocyanates to form polyurethane type polymers. The resulting polymer contains fatty chains that are covalently bonded pendant to the backbone of the polymer. Ethoxylated fatty acids and fatty diamines or similar compounds containing multiple isocyanate cross-linkable moieties can be mixed, with or without the aid of a co-solvent, with the polyol component of commercially available two-component systems to the extent they are soluble. In the case of polyurethane, the linked moiety is similar to that shown in FIG. 1.

FIG. 1. Shows synthesis of a typical polymer of the type described by this invention. R may be any alkyl or alkoxy group of between around 6 to around 22 carbons. R′ and R″ can be the same or different, chosen from a wide range of materials, including, but limited to, H, —(CH2)ₙH, —(CH2)ₙNH2, —[(CH2)ₙNH]ₘ(CH2)ₒ]NH2, with n, m and o from 1 to 30, —(CH2CH2O)ₐ—(CH2CH(CH3)O)_{b}—(CH2CH(CH2CH3)O)_{c}H with a, b, and c integers from 0 to 30, —(CH2)ₓH with x from 1-30, —(CH2)ₙN[(CH2CH2O)ₐ—(CH2CH(CH3)O)_{b}—(CH2CH(CH2CH3)O)_{c}H]—(CH2CH2O)ₐ—(CH2CH(CH3)O)_{b}—(CH2CH(CH2CH3)O)_{c}H, —[(CH2)ₙN(CH2CH2O)ₐ—(CH2CH(CH3)O)_{b}—(CH2CH(CH2CH3)O)_{c}H]m(CH2)ₒ]N[(CH2CH2O)ₐ—(CH2CH(CH3)O)_{b}—(CH2CH(CH2CH3)O)_{c}H]—(CH2CH2O)ₐ—(CH2CH(CH3)O)_{b}—(CH2CH(CH2CH3)O)_{c}H. Together R′ and R″ must contain a total of at least two terminal —NH₂ or —OH or a combination of either totaling at least two. The use of alkoxylated polyamines (at least three terminal —OH groups are present) as included above, produces polymers with tertiary cross linking when reacted with diisocyanates as opposed to the linear structures that result from diisocyanytes and alkoxylated primary amines. Another way to achieve teriary cross linking is to utilize a polyisocyante that has more than two isocyanate groups available for the urea/ urethane reaction.

Quaternary alkoxy amines are produced from alkoxylated amines, and contain at least two terminal —OH groups, such as the Tomah Q-series, and can be polymerized in the same manner as alkxylated amines.

Another embodiment of the invention is the use of fatty ether polyamines or ethoxylated fatty ether amines. FIG. 2 Describes the case in which the fatty moiety is an alkoxy group.

A typical example of an embodiment of the invention is to combine, for example, an ethoxylated amine with a polyisocyanate. By varying the reactants, various hardnesses and flexibilities can be achieved. By varying the type of isocyanate used, the speed of cure can be adjusted. By changing the functionality of the alkyl containing component, different properties can be achieved.

It is an object of the present invention to create a class of hydrophobic urethane and urea polymers with alkyl side chains pendant to the main polymer backbone.

It is another object of the present invention to provide a way to control cross-linking in a hydrophobic polymer by controlling the amount of unsaturation present in pendant side chains.

It is another object of the present invention to provide a way to control cross-linking in a hydrophobic polymer by controlling the number amine groups or alcohol groups in the polyamine/alkoxylated amine reactant utilized.

It is another object of the present invention to provide a way to control cross-linking in a hydrophobic polymer by controlling the number of isocyanates groups present in the polyisocyante.

It is still another object of the present invention to provide a method of making low cost sprayable hydrophobic polymeric coatings.

The preferred embodiment of the present invention is primarily directed toward polyurethane and polyurea structures, but other embodiments can include the incorporation of pendant alkyl structures in other types of polymers that use an amine, carboxylic acid or alcohol group to form the linkage. Other polymer types which can utilize this invention include, but are not limited to, the following: polyamide, polyester, polycarbonate, polyether, polysiloxane, and epoxy.

The presence of pendant saturated or partially unsaturated fatty chains causes the resulting polymers to have hydrophobic and other desirable properties such as the ability to control the amount of final cross-linking between backbones and the pendant chains.

Another application of the invention is the use in water-proof or water resistant, semi-permeable materials. This is achieved by processing the material of the invention in such a way that it contains pores of a size that are larger than that of water vapor, and smaller than a water droplet, roughly on the order of roughly 90 microns in diameter. Processing can be achieved in many ways, including but not limited to, molding, extrusion, sintering, and via air bubble formation during the synthesis reaction or other means of introducing a gas to cause the bubbling for the required pore size. Any method for forming the desired pore size is within the scope of the present invention. The inclusion of these pores allow for the passage of water vapor through the film, while the pores are too small for water droplets to pass through. The hydrophobic nature of the material prevents wicking. Thus, an effective water barrier that allows water vapor to pass through. Altering the pore size allows for similar behavior in regard to molecules other than H₂O.

Alternatively, by controlling the cross-link density of the polymeric material as described in the invention, a matrix can be achieved with the desired permeability. This utilizes the same principles as used in the manufacture of polyacrylamide gels that are used in PAGE electrophoresis for separating proteins of various sizes. The use of varying carbon chain lengths of the starting materials and, in the case of alkoxylated starting materials, the amount of alkoxylation, the properties of the final film can be adjusted to meet the various needs of the final application, such as strength and flexibility. A typical application of the invention would be in the manufacture of water-proof, breathable clothing.

By controlling the cross link density and hydrophobicity as described in the invention, other materials could also be separated. This would provide a means of separating materials from water or other solvents. Other gas phase separations are also within the scope of the invention.

### EXAMPLES

### Example 1

8 g of Tomah E-17-5 (poly (5) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat and foamed during the reaction as well.

### Example 2

6 g of Tomah E-17-2 (poly (2) oxyethylene isotridecyloxypropylamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat, but foamed less than than Example 1. In a repeat of the reaction, the addition FB100 reduced foam substantially and resulted in a product that is much better suited to be a coating.

### Example 3

6 g of Tomah E-17-5 (poly (2) oxyethylene isotridecyloxypropylamine) was added to 10 g of Bayer Mondur N3200 (pre-poly of hexamethylene diisocyanate) and 0.5 g FB100 butyrate antifoam. The resulting tack free solid showed typical polymeric properties as it reacted. During the reaction, a highly fiberous and ordered plastic could be pulled from the vessel. The product reacted much slower than EXAMPLE 2 and foamed much less. This product was suitable as a coating or cast product.

### Example 4

4.3 g Tomah Q-17-5PG (74% active isotridecyloxypropyl poly (5) oxyethylene in propylene Glycol) were added to 10 g of Bayer Mondur E 744 (pre-poly of diphenylmethane 4,4′-diisocyanate). This reaction occurred very slowly with very little visible foaming. The material did form a translucent tack free solid after eight hours.

### Example 5

5.5 g of Crison Crisamine PC-2 (poly (2) oxyethylene primary cocoamine) was added to 10 g of Bayer Mondur E744 (pre-poly of diphenylmethane 4,4′-diisocyanate). The resulting tack free solid showed typical polymeric properties as it reacted. During the reaction, a highly fiberous and ordered plastic could be pulled from the vessel. The product liberated heat and foamed during the reaction but the addition of FB100 butyric antifoam helped reduce this. This material was optically clear. A slight reduction in Bayer Mindur E744 yielded a very soft flexible tack free material.

### Example 6

7 g of Crison Crisamine DC (cocodiamine)dissoloved in 40 g of a 50:50 mixture of naptha and acetone was added to 10 g of Bayer Mondur N3200 (pre-poly of hexamethylene diisocyanate). The products reacted very quickly, even with the solvent present and the aliphatic isocyanate. A tack free rubbery solid formed.

### Example 9

12 g of Tomah DA-17 (Isotridecyloxypropyl-1,3-diaminopropane)was added 10 g to Bayer Mondur N3200 (pre-poly of hexamethylene diisocyanate) in 40 g of naptha. The reaction was almost instantaneous, white strands formed immediately upon contact and a tack free stringy mass resulted after the solvent was evaporated.

### Example 10

10 g of Crison Crisamine PC-2 (poly (2) oxyethylene primary cocoamine) was added to 5.8 g of Bayer Desmodur H (hexamethylene diisocyanate, HDI). The resulting tack free solid had a straw color, but good clarity and moderate to high stiffness with essentially no foaming.

### Example 11

10 g of Crison Crisamine PC-2 (poly (2) oxyethylene primary cocoamine) was combined with 10 g of Crison Crisamine DT-3 (Tris(2-hydroxyethyl)-N-tallowalkyl-1,3-diaminopropane) before being added to 12.9 g of Bayer Desmodur H (hexamethylene diisocyanate, HDI). The resulting material formed a tack free solid more quickly than Example 10. The resulting solid was very elastic with good clarity and essentially no foaming.

I claim:

1. A water vapor permeable, water resistant film comprised of a polymer containing a fatty group pendant to the polymer backbone having the formula: 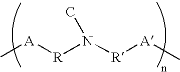
where C is a saturated or unsaturated alkyl group with between about 6 and 22 carbons and R and R′ are the same or different and are independently chosen from the group containing linear or branched, saturated or unsaturated, alkyl, alkenyl, alkylamine, —NH—, —NR—, —(CH₂CH₂O)ₜ—(CH₂CH(CH₃)O)ᵤ—(CH₂CH(CH₂CH₃)O)ᵥ- where t, u, and v are integers greater than or equal to zero, —CH₂CH₂CH₂NYY′ where Y and Y′ are the same or different and independently chosen from the group A and A′ options below, or arylalkyl with 0 to 10 carbon atoms and where A and A′ are the same or different and are independently chosen from the group containing [—(C═O)O—, —O(C═O)NH—, —HN(C═O)NH—, —O—, —OH, —CH₂OH, —CH₃, —(C═O)OH, —O((C═O)CO)ₘ—, —O((C═O)C═C)ₘ—, —N(C═O)—, —O(C═O)C₆H₄(C═O)—, —O(C═O)D-, —OC(C—OH)D-, —(O—SiH₂)ₘ—, —(CH₂)ₗ—] where D is linear or branched, saturated or unsaturated, alkyl, alkenyl, alkylamine or alkylaryl with 0 to 10 carbon atoms, and where I and m are integers greater than zero.

2. The water vapor permeable, water resistant film comprised of a polymer according to claim 1 wherein A and A′ are the same or different and are independently chosen from the group containing [—(C═O)O—, —O(C═O)NH—, —HN(C═O)NH—, —O—, —OH, —CH₂OH, CH₃, —(C═O)OH, —O((C═O)C═C)ₘ—, —N(C═O)—, —(O—SiH₂)ₘ—, —(CH₂)ₘ-—] wherein m is an integer greater than zero.

3. The water vapor permeable, water resistant film of claim 1 wherein the pendant fatty group has an occurrence rate of from around 5 ppm to 100%.

4. The water vapor permeable, water resistant film of claim 1, wherein the effective pore size is greater than the size of a water vapor particle, but smaller than that of a water droplet.

5. The water vapor permeable, water resistant film of claim 1, wherein the effective pore size is from around 30 microns to around 250 microns.
